(19) United States
(12) Patent Application Publication
(10) Pub. No.: US 2025/0239153 A1
(43) Pub. Date: Jul. 24, 2025

(54) CONNECTED VEHICLE CONTROL

(71) Applicant: Ford Global Technologies, LLC, Dearborn, MI (US)

(72) Inventors: Di Shen, Dearborn, MI (US); Qi Dai, Novi, MI (US); Suzhou Huang, Ann Arbor, MI (US); Dimitar Petrov Filev, Novi, MI (US)

(73) Assignee: Ford Global Technologies, LLC, Dearborn, MI (US)

(21) Appl. No.: 18/417,015

(22) Filed: Jan. 19, 2024

(51) Int. Cl. G08G 1/0967; G08G 1/01; G08G 1/052

(52) U.S. Cl. CPC G08G 1/096725; G08G 1/0133; G08G 1/052; G08G 1/096783

(57) ABSTRACT

A system includes a remote computer. The remote computer includes a processor and a memory, and the memory stores instructions executable by the processor to determine a vehicle density over a predefined segment of a road, determine a target speed based on the vehicle density, and transmit the target speed to an ego vehicle. The vehicle density is a number of vehicles per road length over the predefined segment. The vehicles are remote from the remote computer. The target speed is a speed at which the ego vehicle of the vehicles attempts to travel when unimpeded in a forward direction by remaining vehicles of the vehicles.

### BACKGROUND

Advanced driver assistance systems (ADAS) are electronic technologies that assist drivers in driving and parking functions. Examples of ADAS include forward proximity detection, lane-departure detection, blind-spot detection, braking actuation, adaptive cruise control, and lane-keeping assistance systems.

### BRIEF DESCRIPTION OF THE DRAWINGS

FIG. 1 is a diagrammatic top view of an example system with an infrastructure component and vehicles.

FIG. 2 is a block diagram of the system.

FIG. 3 is a flowchart of an example process for a remote computer to provide a target speed to one or more ego vehicles of the vehicles.

FIG. 4 is a flowchart of an example process for a vehicle computer to operate one of the ego vehicles based on the target speed.

### DETAILED DESCRIPTION

This disclosure pertains to controlling at least one vehicle of a plurality of vehicles in a manner that can maintain an efficient average speed of the vehicles and that can have a low likelihood of slowdowns, e.g., a low likelihood of “phantom jams.” “Phantom jams” are temporary traffic jams that spontaneously develop due to typical human driving behaviors, i.e., without exogenous causes such as construction zones or lane closures. A remote computer can monitor a predefined segment of a road, over which a plurality of vehicles are traveling. The vehicles include one or more vehicles with which the remote computer can communicate, which will be referred to as “ego vehicles,” as well as remaining vehicles with which the remote computer cannot or does not communicate. The remote computer is programmed to determine a vehicle density over the predefined segment of the road, determine a target speed based on the vehicle density, and transmit the target speed to the ego vehicle(s). The vehicle density is a number of the vehicles per road length over the predefined segment. The target speed is a speed at which the ego vehicle(s) attempts to travel when unimpeded in a forward direction by the remaining vehicles. The remaining vehicles ahead of the ego vehicle may sometimes speed up when a gap opens up, only to slow down when reaching leading remaining vehicles. The remote computer can set a target speed for the ego vehicle that may buffer the speedup and slowdown from spreading to the remaining vehicles behind the ego vehicle. At the same time, the remote computer can use the vehicle density to set a target speed for the ego vehicle that may result in a high throughput for the predefined segment of the road.

A system includes a remote computer. The remote computer includes a processor and a memory, and the memory stores instructions executable by the processor to determine a vehicle density over a predefined segment of a road, determine a target speed based on the vehicle density, and transmit the target speed to an ego vehicle. The vehicle density is a number of vehicles per road length over the predefined segment. The vehicles are remote from the remote computer. The target speed is a speed at which the ego vehicle of the vehicles attempts to travel when unimpeded in a forward direction by remaining vehicles of the vehicles.

In an example, the vehicles may be traveling at respective actual speeds, and the instructions may further include instructions to determine the target speed based on optimizing a combination of a mean of the actual speeds and a spread of the actual speeds, the spread being a difference between a highest speed of the actual speeds and a lowest speed of the actual speeds. In a further example, the combination of the mean and the spread may be a difference between the mean and the spread with at least one of the mean and the spread weighted by a tradeoff parameter.

In another further example, the actual speeds of the vehicles for each value of the mean and of the spread may be from a same time. In a yet further example, the instructions may further include instructions to optimize the combination of the mean and the spread over a time horizon.

In an example, the vehicles may be traveling at respective actual speeds, and the instructions may further include instructions to determine the target speed based on minimizing a spread of the actual speeds, the spread being a difference between a highest speed of the actual speeds and a lowest speed of the actual speeds. In a further example, the actual speeds of the vehicles for each value of the spread may be from a same time.

In an example, the vehicles may be traveling at respective actual speeds, and the instructions may further include instructions to determine the target speed based on maximizing a mean of the actual speeds. In a further example, the actual speeds of the vehicles for each value of the mean may be from a same time.

In an example, the vehicle density may be a mean over a plurality of timesteps of an instantaneous vehicle density at the timesteps.

In an example, the system may further include the ego vehicle, the ego vehicle including a vehicle computer, the vehicle computer being programmed to execute an adaptive cruise control based on the target speed.

In an example, the target speed may be a posted speed limit for the road.

In an example, the instructions may further include instructions to broadcast the target speed over the predefined segment of the road.

In an example, the remote computer may be communicatively coupled to the ego vehicle, and the remote computer may be not communicatively coupled to at least one of the remaining vehicles.

A method includes determining a vehicle density over a predefined segment of a road, determining a target speed based on the vehicle density, and transmitting the target speed to an ego vehicle. The vehicle density is a number of vehicles per road length over the predefined segment. The vehicles are remote from the remote computer. The target speed is a speed at which the ego vehicle of the vehicles attempts to travel when unimpeded in a forward direction by remaining vehicles of the vehicles.

In an example, the method further includes executing an adaptive cruise control on board the ego vehicle based on the target speed.

In an example, the vehicles may be traveling at respective actual speeds, the method further comprising determining the target speed based on optimizing a combination of a mean of the actual speeds and a spread of the actual speeds, the spread being a difference between a highest speed of the actual speeds and a lowest speed of the actual speeds. In a further example, the combination of the mean and the spread may be a difference between the mean and the spread with at least one of the mean and the spread weighted by a tradeoff parameter.

In another further example, the actual speeds of the vehicles for each value of the mean and of the spread may be from a same time. In a yet further example, the method may further include optimizing the combination of the mean and the spread over a time horizon.

With reference to the Figures, wherein like numerals indicate like parts throughout the several views, a system 100 includes a remote computer 205. The remote computer 205 includes a processor and a memory, and the memory stores instructions executable by the processor to determine a vehicle density over a predefined segment 120 of a road 115, determine a target speed based on the vehicle density, and transmit the target speed to an ego vehicle 105. The vehicle density is a number of vehicles 105, 110 per road length over the predefined segment 120. The vehicles 105, 110 are remote from the remote computer 205. The target speed is a speed at which the ego vehicle 105 of the vehicles 105, 110 attempts to travel when unimpeded in a forward direction by remaining vehicles 110 of the vehicles 105, 110.

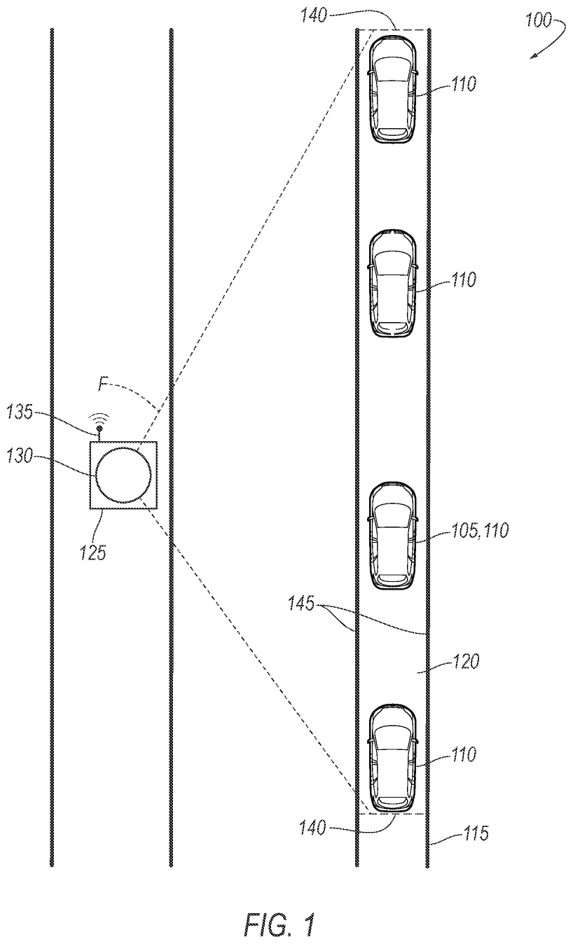

With reference to FIG. 1, an infrastructure component 125 may be located next to the road 115. The road 115 may have multiple lanes or a single lane. One or more ego vehicles 105 and one or more remaining vehicles 110 may be traveling on the road 115. The term “ego vehicle” is used herein to refer to a connected vehicle that is configured to act upon a message received from the infrastructure component 125. The term “remaining vehicle” is used herein to refer to the other vehicles on the road 115 from the perspective of the ego vehicle 105. If multiple connected vehicles capable of acting as ego vehicles 105 are traveling on the road 115, each such vehicle is also a remaining vehicle 110 from the perspective of the other connected vehicles. The vehicles 105, 110 are remote from the infrastructure component 125, i.e., distinct and spaced from the infrastructure component 125.

The system 100 includes the infrastructure component 125 and the ego vehicles 105. The system 100 may be formed by one or more ego vehicles 105 being within range of an infrastructure transceiver 135 of the infrastructure component 125 or traveling over the predefined segment 120 of the road 115. Which ego vehicles 105 are part of the system 100 with the infrastructure component 125 may thus change dynamically over time.

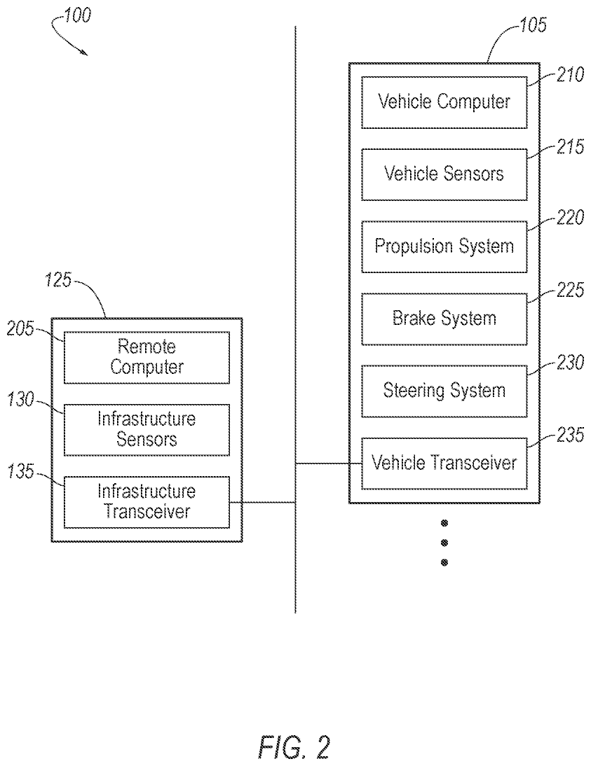

The infrastructure component 125 may include the remote computer 205 (shown in FIG. 2), at least one infrastructure sensor 130, and an infrastructure transceiver 135. The infrastructure component 125 may be fixed in position relative to the road 115, e.g., at a location next to the road 115. The road 115 may have multiple such infrastructure components 125 spaced from each other at regular intervals along the road 115. Alternatively, the remote computer 205, the infrastructure sensor 130, and the infrastructure transceiver 135 may be separate components fixed in separate locations along the road 115. In this alternative, the remote computer 205, the infrastructure sensor 130, and the infrastructure transceiver 135 are communicatively coupled with a wired and/or wireless connection.

Each infrastructure sensor 130 has a field of view F encompassing the road 115. The position of the infrastructure component 125 may provide the infrastructure sensors 130 with the fields of view F that encompass the road 115. For example, the infrastructure sensor 130 may be mounted to a body of the infrastructure component 125 at an elevated location that is near the road 115, and the infrastructure sensor 130 may be oriented downward toward the road 115. The regular spacing of the infrastructure components 125 may be such that the fields of view F of infrastructure sensors 130 on adjacent infrastructure components 125 overlap.

The position of the infrastructure component 125 puts the infrastructure transceiver 135 in range of the road 115. The regular spacing of the infrastructure components 125 may be such that the ranges of infrastructure transceivers 135 on adjacent infrastructure components 125 overlap. The ego vehicles 105 may thus switch from one infrastructure component 125 to the next infrastructure component 125 while traveling along the road 115.

With reference to FIG. 2, the infrastructure component 125 may include the remote computer 205, the at least one infrastructure sensor 130, and the infrastructure transceiver 135. The infrastructure computer is communicatively coupled to the infrastructure sensor 130 and the infrastructure transceiver 135, e.g., via a bus within a body of the infrastructure component 125.

The system 100, e.g., the infrastructure component 125, includes the remote computer 205. The remote computer 205 is a microprocessor-based computing device, e.g., a generic computing device including a processor and a memory. The memory of the remote computer 205 can include media for storing instructions executable by the processor as well as for electronically storing data and/or databases, and/or the remote computer 205 can include structures such as the foregoing by which programming is provided. The remote computer 205 can be multiple computers coupled together.

The infrastructure sensors 130 may detect the external world, e.g., objects and/or characteristics of surroundings of the infrastructure component 125, such as the vehicles 105, 110, road lane markings, traffic lights and/or signs, pedestrians, etc. For example, the infrastructure sensors 130 may include a camera. The camera can detect electromagnetic radiation in some range of wavelengths. For example, the camera may detect visible light, infrared radiation, ultraviolet light, or some range of wavelengths including visible, infrared, and/or ultraviolet light. For example, the camera can be a charge-coupled device (CCD), complementary metal oxide semiconductor (CMOS), or any other suitable type. For another example, the infrastructure sensors 130 may include a lidar, e.g., a scanning lidar device. The lidar detects distances to objects by emitting laser pulses at a particular wavelength and measuring the time of flight for the pulse to travel to the object and back. The lidar can be any suitable type for providing the lidar data on which the remote computer 205 can act, e.g., spindle-type lidar, solid-state lidar, flash lidar, etc. For another example, the infrastructure sensors 130 may include a radar. The radar transmits radio waves and receives reflections of those radio waves to detect physical objects in the environment. The radar can use direct propagation, i.e., measuring time delays between transmission and reception of radio waves, and/or indirect propagation, i.e., Frequency Modulated Continuous Wave (FMCW) method, i.e., measuring changes in frequency between transmitted and received radio waves.

The infrastructure transceiver 135 may be adapted to transmit signals wirelessly with the ego vehicles 105 through any suitable wireless communication protocol, such as cellular, Bluetooth®, Bluetooth® Low Energy (BLE), ultra-wideband (UWB), WiFi, IEEE 802.11a/b/g/p, cellular-V2X (CV2X), Dedicated Short-Range Communications (DSRC), other RF (radio frequency) communications, etc. The infrastructure transceiver 135 may thus facilitate vehicle-to-infrastructure (V2I) communications. The infrastructure transceiver 135 may be one device or may include a separate transmitter and receiver. The remote computer 205 may be communicatively coupled to the ego vehicles 105 via the infrastructure transceiver 135. The remote computer 205 may be not communicatively coupled to at least one of the remaining vehicles 110, either because the remaining vehicle 110 is unequipped to communicate with the infrastructure transceiver 135 or declines to establish a connection with the infrastructure transceiver 135.

The ego vehicles 105 may each be any passenger or commercial automobile such as a car, a truck, a sport utility vehicle, a crossover, a van, a minivan, a taxi, a bus, etc. Each ego vehicle 105 includes a vehicle computer 210, vehicle sensors 215, a propulsion system 220, a brake system 225, a steering system 230, and a vehicle transceiver 235. The vehicle computer 210 may be communicatively coupled to the vehicle sensors 215, the propulsion system 220, the brake system 225, the steering system 230, and the vehicle transceiver 235, e.g., via a vehicle network such as a controller area network (CAN) bus.

The vehicle computer 210 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The vehicle computer 210 can thus include a processor, a memory, etc. The memory of the vehicle computer 210 can include media for storing instructions executable by the processor as well as for electronically storing data and/or databases, and/or the vehicle computer 210 can include structures such as the foregoing by which programming is provided. The vehicle computer 210 can be multiple computers coupled together.

The vehicle sensors 215 may provide data about operation of the ego vehicle 105, for example, wheel speed, wheel orientation, and engine and transmission data (e.g., temperature, fuel consumption, etc.). The vehicle sensors 215 may detect the location and/or orientation of the ego vehicle 105. For example, the vehicle sensors 215 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The vehicle sensors 215 may detect the external world, e.g., objects and/or characteristics of surroundings of the ego vehicle 105, such as the remaining vehicles 110, road lane markings, traffic lights and/or signs, pedestrians, etc. For example, the vehicle sensors 215 may include radar sensors, ultrasonic sensors, scanning laser range finders, light detection and ranging (lidar) devices, and image processing sensors such as cameras.

The propulsion system 220 of the ego vehicle 105 generates energy and translates the energy into motion of the ego vehicle 105. The propulsion system 220 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 220 can include an electronic control unit (ECU) or the like that is in communication with and receives input from the vehicle computer 210 and/or a human operator. The human operator may control the propulsion system 220 via, e.g., an accelerator pedal and/or a gear-shift lever.

The brake system 225 is typically a conventional vehicle braking subsystem and resists the motion of the ego vehicle 105 to thereby slow and/or stop the ego vehicle 105. The brake system 225 may include friction brakes such as disc brakes, drum brakes, band brakes, etc.; regenerative brakes; any other suitable type of brakes; or a combination. The brake system 225 can include an electronic control unit (ECU) or the like that is in communication with and receives input from the vehicle computer 210 and/or a human operator. The human operator may control the brake system 225 via, e.g., a brake pedal.

The steering system 230 is typically a conventional vehicle steering subsystem and controls the turning of the wheels. The steering system 230 may be a rack-and-pinion system with electric power-assisted steering, a steer-by-wire system, as both are known, or any other suitable system. The steering system 230 can include an electronic control unit (ECU) or the like that is in communication with and receives input from the vehicle computer 210 and/or a human operator. The human operator may control the steering system 230 via, e.g., a steering wheel.

The vehicle transceiver 235 may be adapted to transmit signals wirelessly through any suitable wireless communication protocol, including the same protocol used by the infrastructure transceiver 135 and possibly other protocols. The vehicle transceiver 235 may be one device or may include a separate transmitter and receiver.

Returning to FIG. 1, the remote computer 205 is programmed to receive data from the infrastructure sensors 130. For example, the data may be image data. The image data are a sequence of image frames of the field of view F of the camera. Each image frame is a two-dimensional matrix of pixels. Each pixel has a brightness or color represented as one or more numerical values, e.g., a scalar unitless value of photometric light intensity between 0 (black) and 1 (white), or values for each of red, green, and blue, e.g., each on an 8-bit scale (0 to 255) or a 12- or 16-bit scale. The pixels may be a mix of representations, e.g., a repeating pattern of scalar values of intensity for three pixels and a fourth pixel with three numerical color values, or some other pattern. Position in an image frame, i.e., position in the field of view F of the sensor at the time that the image frame was recorded, can be specified in pixel dimensions or coordinates, e.g., an ordered pair of pixel distances, such as a number of pixels from a top edge and a number of pixels from a left edge of the image frame.

For another example, the data may be range data. The range data may be, e.g., a sequence of point clouds of the field of view F of a ranging sensor such as the lidar or radar. The points of the point cloud specify respective positions in the environment relative to the position of the ranging sensor. For example, the range data can be in spherical coordinates with the ranging sensor at the origin of the spherical coordinate system. The spherical coordinates can include a radial distance, i.e., a measured depth from the ranging sensor to the point measured by the ranging sensor; a polar angle, i.e., an angle from a vertical axis through the ranging sensor to the point measured by the ranging sensor; and an azimuthal angle, i.e., an angle in a horizontal plane from a horizontal axis through the ranging sensor to the point measured by the ranging sensor. The horizontal axis can be, e.g., along a vehicle-forward direction. Alternatively, the ranging sensor can return the points as Cartesian coordinates with the ranging sensor at the origin or as coordinates in any other suitable coordinate system, or the remote computer 205 can convert the spherical coordinates to Cartesian coordinates or another coordinate system after receiving the range data.

The vehicles 105, 110 are traveling on a predefined segment 120 of the same road 115. The predefined segment 120 is an area of the road 115 having a fixed boundary stored in the memory of the remote computer 205. The boundary may be defined by two longitudinal endpoints 140 spaced in the direction of travel of the road 115 and by lane boundaries 145 extending from one of the longitudinal endpoints 140 to the other of the longitudinal endpoints 140. For the purposes of this disclosure, “longitudinal” refers to a forward-rearward dimension relative to the lane of the road 115, and “lateral” refers to a sideways dimension relative to the lane of the road 115. In the specific example described herein, the vehicles 105, 110 are traveling the same direction on the same one-lane road 115 or on the same lane of a multilane road 115. The predefined segment 120 is thus defined by the lane boundaries 145 of a single lane extending from one longitudinal endpoint 140 to another longitudinal endpoint 140. The techniques herein may be extended to other scenarios in which the vehicles 105, 110 are interacting in the same predefined segment 120.

When describing the programming of one of the vehicle computers 210, the modifier “ego” refers to the vehicle 105 including that specific vehicle computer 210, and the modifier “remaining” refers to the other vehicles 110, which do not include that specific vehicle computer 210. For ease of description, the programming of a single vehicle computer 210 will be described. The same programming may be implemented on all the vehicle computers 210 of the ego vehicles 105.

The determinations described below may be performed for a set of future timesteps. The future timesteps are discrete instances in time. The future timesteps may have a uniform length Δt chosen based on a calculation speed of the vehicle computers 210 and/or the remote computer 205 and a latency in communication between the remote computer 205 and the ego vehicles 105. The future timesteps may start at a next timestep after a current timestep. The set of future timesteps may define a time horizon, i.e., a maximum length of time from a current time into the future for which the calculations are performed. The time horizon may be defined by a number H of timesteps, meaning that the length of the time horizon is given by HΔt.

The remote computer 205 may be programmed to receive or determine kinematic states of one or more of the vehicles 105, 110. For the purposes of this disclosure, a “kinematic state” is defined as a mathematical description of the position and/or motion of an entity. For example, the kinematic state of each vehicle may include a position, a velocity, and an acceleration, e.g., ξ_{i,t}={x_{i,t}, v_{i,t}, a_{i,t}}, in which the subscript i is an index value of the vehicle 105, the subscript t is a value of the timestep, x is the position, v is the velocity, and a is the acceleration. For a one-lane road 115, the position x, the velocity v, and the acceleration a may be one-dimensional, i.e., scalar, with positive values indicating the direction of forward travel on the road 115 and negative values indicating the direction of rearward travel on the road 115. For example, the remote computer 205 may receive transmissions from the ego vehicles 105 including the kinematic states of the ego vehicles 105. For another example, the remote computer 205 may determine the kinematic states of the vehicles 105, 110 based on the sensor data from the infrastructure sensors 130.

The vehicle computer 210 may be programmed to actuate the ego vehicle 105 according to a control input u_{i,t}. For the purposes of this disclosure, a “control input” is one or more values that control operation of a component of a vehicle. For example, the vehicle computer 210 may actuate the propulsion system 220 and/or the brake system 225 of the ego vehicle 105 according to the control input u_{i,t}. The control input u_{i,t} may specify acceleration of the ego vehicle 105. Actuating the propulsion system 220 according to the control input can include, for positive values of the control input u_{i,t}, engaging a throttle to match the acceleration a_{i,t} of the ego vehicle 105 to the control input u_{i,t}. Actuating the brake system 225 according to the control input can include, for negative values of the control input u_{i,t}, engaging the brake system 225 so that the acceleration a_{i,t} of the vehicle 105 matches the control input u_{i,t}.

The remote computer 205 may be programmed to determine a projected kinematic state of one or more of the vehicles 105, 110 at a future timestep. The remote computer 205 may execute a physics-based model of the vehicle based on the kinematic state of the vehicle 105, 110 at the previous timestep and the projected control inputs to the vehicle 105, 110. For example, the position of the vehicle 105, 110 at a future timestep may be a sum of the position at the immediately previous timestep and a product of the velocity at the immediately previous timestep and the length of a timestep. The position may be calculated with a preset modulo, which in effect models the single-lane road 115 as a ring with a circumference equal to the modulo. The preset modulo may be the path length of the predefined segment 120. A ring model can simplify calculations through future timesteps with no loss of accuracy. The velocity of the vehicle 105, 110 at a future timestep may be a sum of the velocity at the immediately previous timestep and a product of the acceleration at the immediately previous timestep and the length of a timestep. The acceleration may be weighted between the acceleration at the previous timestep, the control input at the previous timestep, and the control input at the second most recent timestep. The remote computer 205 may determine the projected kinematic state at the future timestep iteratively, e.g., starting from a current timestep and determining each timestep up to the future timestep, e.g., as in the following set of expressions:

$${x}_{i , t + 1} = {x}_{i , t} + {v}_{i , t} Δ t + {μ}_{i , t + 1}^{x} , ( mod C )$$

$${v}_{i , t + 1} = {v}_{i , t} + {a}_{i , t} Δ t + {μ}_{i , t + 1}^{v}$$

$${a}_{i , t + 1} = γ {a}_{i , t} + ( {\overline{u}}_{i , t} - γ {\overline{u}}_{i , t - 1} ) + {μ}_{i , t + 1}^{a}$$

in which μ indicates a noise term, C is the modulo, γ is the weight for the acceleration, and ū is the projected control input. The modulo C, e.g., the path length of the predefined segment 120, may be chosen to be sufficiently large to encompass all the vehicles 105, 110. The weight γ may be a preset value chosen based on how reactive the propulsion system 220 and brake system 225 typically are. The projected control inputs may be chosen by, e.g., assuming that the vehicles 105, 110 operate so as to maximize the utility functions described below.

As will be described below, the remote computer 205 determines a target speed for the ego vehicles 105 and transmits the target speed to the ego vehicles 105. The target speed is a speed at which an ego vehicle 105 attempts to travel when unimpeded in a forward direction by the remaining vehicles 110, i.e., a speed at which an ego vehicle 105 attempts to travel, subject to constraints such as proximity to the remaining vehicles 110.

The vehicle computer 210 or remote computer 205 is programmed to determine a value of a utility function. For example, the vehicle computer 210 may determine the value of the utility function in one example of determining the control input based on the target speed, as described below. For another example, the remote computer 205 may determine the value of the utility function in one example of determining the target speed, as described below. The form of the utility function is chosen to reward or penalize certain actions by a vehicle 105, 110. The utility function may include terms relating to forward motion of the vehicle 105, 110, rearward motion of the vehicle 105, 110, and/or proximity of the vehicle 105, 110 to other vehicles 105, 110, which are described in turn below. The utility function may be a sum over the timesteps of the time horizon of a sum of the terms, e.g., with each term weighted to make the terms commensurable and to express a priority among the terms, e.g., as in the following expression:

$${U}_{i , t}^{eff} = {\sum }_{t = 0}^{H} {\sum }_{k} {w}_{k} {U}_{i , t}^{( k )}$$

in which k is an index of the terms, w is the weight, and U is the term. Parentheses are used to indicate when a variable is a superscript rather than a power. The index k may be 1 for forward motion, 2 for rearward motion, and 3 for proximity to other vehicles 105, 110.

The utility function, e.g., the first term of the utility function, may reward forward motion of the vehicle of interest up to the target speed vᵢ*. For example, the first term may include a difference between the velocity v_{i,t} of the vehicle 105 (possibly adjusted to the next timestep using the acceleration a_{i,t}) and the optimal speed vᵢ*. The first term may be an exponential function, i.e., Euler's number e raised to the power of the argument, which can provide greater differentiation as the velocity v_{i,t} of the vehicle 105 and the optimal speed vᵢ* get closer. For example, the first term may be given by the following expression:

$${U}_{i , t}^{( 1 )} = exp ( - {( \frac{{v}_{i , t} + {a}_{i , t} Δ t - {v}_{i}^{*}}{{κ}_{i}^{( 1 )} {v}_{i}^{*}} )}^{2} )$$

in which exp( ) is the exponential function, and κᵢ⁽¹⁾ is a scaling term. The weight w₁ for the first term may be a positive value to indicate that forward motion is favored, e.g., 1.

The utility function, e.g., the second term of the utility function, may penalize reverse motion of the ego vehicle 105. For example, the second term may be the exponential function of the negation of the velocity v_{i,t} of the vehicle (possibly adjusted to the next timestep using the acceleration a_{i,t}), e.g., as in the following expression:

$${U}_{i , t}^{( 2 )} = exp ( - {κ}_{v , i}^{( 2 )} ( {v}_{i , t} + {a}_{i , t} Δ t + {κ}_{0 , i}^{( 2 )} ) )$$

in which κ_{v,i}⁽²⁾ and κ_{0,i}⁽²⁾ are scaling or adjustment terms. The weight w₂ for the second term may be a negative value to indicate that reverse motion is disfavored, e.g., −1.

The utility function, e.g., the third term of the utility function, penalizes proximity of the ego vehicle 105 to one of the remaining vehicles 110, e.g., a remaining vehicle 110 traveling immediately forward from the ego vehicle 105, which will be referred to as the leading remaining vehicle 110. For example, the third term may be based on a distance between the ego vehicle 105 and the leading remaining vehicle 110, e.g., a bumper-to-bumper distance from the front of the ego vehicle 105 to the rear of the leading remaining vehicle 110. The third term may be based on a ratio between the distance and a function of the velocities of the ego vehicle 105 and the leading remaining vehicle 110. The function of the velocities may increase with the velocity of the ego vehicle 105 and may increase when the ego vehicle 105 is moving closer to the leading vehicle, as indicated by their velocities. For example, the third term may be given by the following set of expressions:

$${U}_{i , t}^{( 3 )} = \{ \begin{matrix}1 , & Δ {x}_{i , i + 1 , t} \leq 0 \\ exp ( - {( \frac{Δ {x}_{i , i + 1 , t}}{{δ}_{i , i + 1 , t}} )}^{2} - ( \frac{Δ {x}_{i , i + 1 , t}}{{δ}_{i , i + 1 , t}} ) ) , & Δ {x}_{i , i + 1 , t} > 0\end{matrix}$$

$$Δ {x}_{i , i + 1 , t} = ( {x}_{i + 1 , t} + {v}_{i + 1 , t} Δ t - {L}_{i + 1} / 2 ) - ( {x}_{i , t} + {v}_{i , t} Δ t + {L}_{i} / 2 )$$

$${δ}_{i , i + 1 , t} = {κ}_{c , i}^{( 3 )} + {κ}_{v , i}^{( 3 )} \vert {v}_{i , t} + {a}_{i , t} Δ t \vert + {κ}_{d , i}^{( 3 )} max ( {v}_{i , t} + {a}_{i , t} Δ t - ( {v}_{i + 1 , t} + {a}_{i + 1 , t} Δ t ) , 0 )$$

in which Δx_{i,j,t} is the bumper-to-bumper distance between the ith and jth vehicles 105, 110 at the tth timestep, δ is the function of the velocities, Lᵢ is the length of the ith vehicle, and κ_{c,i}⁽³⁾, κ_{v,i}⁽³⁾, and κ_{d,i}⁽³⁾ are scaling or adjustment terms. The weight w₃ for the third term may be a negative value to indicate that reverse motion is disfavored and may have a greater magnitude than either of the weights w₁, w₂ to indicate a greater priority for the third term, e.g., −10.

Alternatively, the utility function may be a sum of transforms of the foregoing terms, e.g., with each transformed term weighted as described above, e.g., as in the following expression:

$${U}_{i , t}^{eff} = {\sum }_{k} {w}_{k} {g}_{k} ( {U}_{i , t}^{( k )} )$$

in which gₖ is the transform function for the kth term. The transform functions may be chosen to make the predictions closer to typical human operation of the vehicles 105, 110, e.g., if the utility function is used by the remote computer 205 for determining the target speed. The transform functions represent the utility for each term over the time horizon, rather than at a single timestep, so the expression above lacks a summation over the timesteps. For example, the respective transform functions g₁, g₂ for the first term and the second term may be the substitution of the projected kinematic states at the next timestep t+1 for the kinematic states at the current timestep t. The transform function g₃ for the third term may be the maximum value for the third term among the future timesteps from the next timestep t+1 for the length of the time horizon t+H+1.

The remote computer 205 may be programmed to determine one or more aggregate values characterizing the vehicles 105, 110 as a group. The aggregate values may include, e.g., the vehicle density, the mean speed, and the speed spread, which will be described in turn below. The aggregate values may be based on the actual speeds of the vehicles 105, 110. The term “actual” refers to the speed that the vehicle 105, 110 is actually traveling, as distinguished from a predicted or projected speed of a vehicle 105, 110 or an average speed of a vehicle 105, 110 over time or of multiple vehicles 105, 110. The vehicles 105, 110 are traveling at respective actual speeds, which may be different from each other.

The remote computer 205 is programmed to determine the vehicle density over the predefined segment 120 of the road 115. The vehicle density is a number of vehicles 105, 110 per road length over the predefined segment 120. For example, the vehicle density may be a mean over a plurality of timesteps of an instantaneous vehicle density at the timesteps. The instantaneous vehicle density may be the number of vehicles 105, 110 in the predefined segment 120 divided by the path length of the predefined segment 120, e.g., as in the following expression:

$$ρ ( t ) = \frac{N ( t )}{L}$$

in which ρ is the instantaneous vehicle density, N is the number of vehicles 105, 110 on the predefined segment 120 at time t, and L is the path length of the predefined segment 120. The vehicle density may be the mean of the instantaneous vehicle density over a plurality of timesteps, e.g., over a preset number of timesteps, e.g., as in the following expression:

$$S ( t ) = \frac{1}{τ} {\sum }_{{t}^{′} = 1}^{τ} ρ ( t - {t}^{′} )$$

in which S is the vehicle density, τ is the preset number of timesteps, and t′ is an index to count over the timesteps from a first timestep t−τ to a current timestep t. Averaging the instantaneous vehicle densities may smooth out outlier values to give a more reliable measure of the vehicle density than using the most recent instantaneous vehicle density.

The remote computer 205 may be programmed to determine a mean speed of the vehicles 105, 110. For example, the remote computer 205 may determine an instantaneous mean speed, for which the actual speeds of the vehicles 105, 110 for each value of the mean are from a same time, as in the following expression:

$$V ( t ) = \frac{1}{N} {\sum }_{i = 1}^{N} {v}_{i , t}$$

in which V is the mean speed, i is an index of the vehicles 105, 110 on the predefined segment 120, and N is the number of vehicles 105, 110 on the predefined segment 120. The mean speed may thus be a function of time and may represent the mean of the actual speeds at each time t.

The remote computer 205 may be programmed to determine a speed spread of the vehicles 105, 110. A speed spread is a difference between a highest speed and a lowest speed. For example, the remote computer 205 may determine an instantaneous speed spread, for which the spread is between a highest speed of the actual speeds and a lowest speed of the actual speeds from a same time t, e.g., as in the following expression:

$$R ( t ) = {max}_{i} {v}_{i , t} - {min}_{i} {v}_{i , t}$$

in which R is the speed spread, i is an index of the vehicles 105, 110 on the predefined segment 120,

$${max}_{i} ( )$$

is the maximum value or the argument achieved by varying t, and

$${min}_{i} ( )$$

is the minimum value of the argument achieved by varying i.

In order to determine the target speed, the remote computer 205 may determine the value of an objective function. As will be described below, the remote computer 205 may determine the value for the target speed that optimizes the objective function, i.e., either maximizes or minimizes the objective function, whichever is considered beneficial. The objective function may be a combination of the mean speed and the speed spread. For example, the combination of the mean speed and the speed spread may be a difference between the mean speed and the speed spread with at least one of the mean speed and the speed spread weighted by a tradeoff parameter, e.g., as in the following expression:

$$\prod ( {v}_{1}^{*} \vert N , ω ) = \frac{1}{T} {\sum }_{t = 1}^{T} ( V ( t ) - ω R ( t ) )$$

in which Π is the objective function, v₁* is the target speed for the ego vehicle 105 (arbitrarily assigned the index i=1), ω is the tradeoff parameter, and T is the time horizon. A difference between the mean speed and the speed spread is used because the mean speed and the speed spread are beneficial in opposite directions, i.e., a higher mean speed and a lower speed spread are better. The tradeoff parameter ω may be chosen so that both the mean speed and the speed spread are afforded significant weight when optimizing the objective function to find the target speed, e.g., 0.5. The inventors have discovered that, when optimizing the objective function, the vehicle density has a significantly stronger effect on the value of the target speed than the tradeoff parameter does.

The remote computer 205 is programmed to determine the target speed based on the vehicle density. For example, the remote computer 205 determines the target speed based on optimizing the combination of the mean speed and the speed spread, e.g., the objective function, which means maximizing the mean speed and minimizing the speed spread, as can be seen from the form of the objective function above. The optimization may be performed over the time horizon T, as can be seen from the form of the objective function above. For example, the remote computer 205 may execute an optimization algorithm, as will be described below, with the current vehicle density as an input. For another example, the remote computer 205 may store a relationship between the target speed and the vehicle density, e.g., the target speed as a function of the vehicle density, i.e., v₁*=ƒ(S). The function may be an analytical function, i.e., a mathematical expression, or a numerical function, e.g., in the form of a lookup table. The function may be derived by executing the optimization algorithm described below for different vehicle densities. The function thus represents the optimization of the objective function. Predetermining the function offline and storing the function in the remote computer 205 is more computationally efficient than executing the optimization algorithm continuously by the remote computer 205. The remote computer 205 may thus be able to determine the target speed using the function sufficiently quickly to operate in real time.

The optimization algorithm determines the target speed that maximizes the objective function, holding the vehicle density constant. The remote computer 205 may execute the optimization algorithm with the current vehicle density as an input, or another computer may execute the optimization algorithm multiple times for several different vehicle densities in order to determine the function ƒ. As a general overview of one execution of the optimization algorithm, a simulation of the vehicles 105, 110 traveling over the predefined segment 120 is performed once for each of a range of values for the target speed, e.g., with the target speed v₁* ranging from 1 m/s to 8 m/s in increments of 0.01 m/s. The value of the objective function is determined for each simulation, and the output of the optimization algorithm is the target speed having the greatest value for the objective function.

For each simulation, the optimization algorithm determines the projected control inputs for each vehicle that serve as a best response to the projected control inputs of the other vehicles 105, 110, with “best response” being measured with the utility function described above. First, the optimization algorithm initializes the projected control inputs to preset values, e.g., the final projected control inputs from the previous timestep, or zero. Then, the optimization algorithm determines the projected kinematic states of the vehicles 105, 110 based on the initialized projected control inputs, as described above. Next, the optimization algorithm determines the total value of the utility function for each vehicle 105, 110 based on the projected kinematic states. Then, the optimization algorithm updates the projected control inputs for each vehicle 105, 110, e.g., by performing a grid search on a parameterized set of the projected control inputs. Finally, the optimization algorithm determines the projected kinematic states for the vehicles 105, 110 based on the updated projected control inputs, with the projected kinematic states determined at this step being used as inputs for the objective function as described above.

The remote computer 205 is programmed to, upon determining the target speed, transmit the target speed to the ego vehicle 105. For example, for each ego vehicle 105, the remote computer 205 may instruct the infrastructure transceiver 135 to transmit a message including the target speed to the ego vehicle 105 via a communication session established between the infrastructure transceiver 135 and the vehicle transceiver 235 of that ego vehicle 105. The infrastructure transceiver 135 and the vehicle transceiver 235 may establish the communication session in response to the ego vehicle 105 entering the range of the infrastructure transceiver 135. For another example, the remote computer 205 may broadcast the target speed over the predefined segment 120 of the road 115. The remote computer 205 may instruct the infrastructure transceiver 135 to transmit a message including the target speed over a band that is available for any ego vehicle 105 to access. Any ego vehicle 105 that is within the range of the infrastructure transceiver 135 may thereby be able to receive the target speed.

The vehicle computer 210 of the ego vehicle 105 may be programmed to operate the ego vehicle 105 based on the target speed, e.g., to travel at the target speed. For example, the remote computer 205 and the ego vehicle 105 may be under the same authority, and the message from the remote computer 205 may be a command for the ego vehicle 105 to travel at the target speed (subject to other constraints). The vehicle computer 210 may determine projected control inputs based on the target speed and based on sensor data indicating the remaining vehicles 110, e.g., by determining a best response according to the projected kinematic states and maximizing the utility function, as described above. As noted above, the target speed is an input to the utility function.

For another example, the vehicle computer 210 of the ego vehicle 105 may be programmed to execute an adaptive cruise control based on the target speed. Adaptive cruise control is an advanced driver assistance system (ADAS) that operates a vehicle at a user-inputted speed unless a leading vehicle is less than a threshold distance in front of the vehicle, in which case the adaptive cruise control operates the vehicle at lower than the user-inputted speed. The adaptive cruise control may actuate the propulsion system 220 to accelerate up to the user-inputted speed or maintain the speed of the vehicle at the user-inputted speed, and the adaptive cruise control may actuate the brake system 225 such that the vehicle does not exceed the user-inputted speed or move within the threshold distance from the leading vehicle. The adaptive cruise control may output a control input for the vehicle computer 210 to use to actuate the propulsion system 220 and/or the brake system 225. The vehicle computer 210 may be programmed to execute the adaptive cruise control with the target speed as the user-inputted speed. The vehicle computer 210 may output a prompt to an operator asking for a confirmatory input to use the target speed as the user-inputted speed for the adaptive cruise control.

For another example, the target speed may be a posted speed limit for the road 115. The predefined segment 120 of the road 115 may be designated as having a variable speed limit rather than a fixed speed limit. A posted speed limit is a maximum permissible speed at which vehicles 105, 110 can operate on a road 115, as set by a jurisdiction having authority over the road 115. The message from the remote computer 205 to the ego vehicle 105 may identify the target speed as the posted speed limit for the road 115. Electronic signs along the road 115 may display the target speed as the posted speed limit for the road 115 so that the target speed is visible to operators of the vehicles 105, 110.

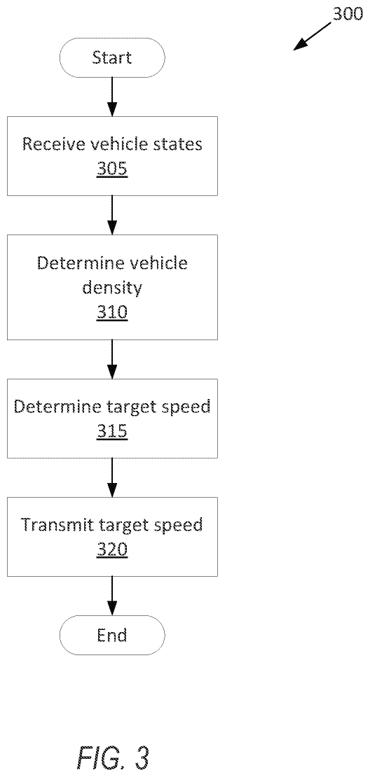

FIG. 3 is a flowchart illustrating an example process 300 for providing the target speed to the ego vehicles 105. The memory of the remote computer 205 stores executable instructions for performing the steps of the process 300 and/or programming can be implemented in structures such as mentioned above. As a general overview of the process 300, the remote computer 205 receives the vehicle kinematic states, determines the vehicle density over the predefined segment 120, determines the target speed based on the vehicle density, and transmits the target speed to the ego vehicles 105. The remote computer 205 may perform the process 300 continuously while the infrastructure component 125 is in use.

The process 300 begins in a block 305, in which the remote computer 205 receives the vehicle kinematic states of the vehicles 105, 110, e.g., sensor data indicating the vehicle kinematic states, as described above.

Next, in a block 310, the remote computer 205 determines the vehicle density over the predefined segment 120 of the road 115, as described above.

Next, in a block 315, the remote computer 205 determines the target speed based on the vehicle density from the block 310, as described above.

Next, in a block 320, the remote computer 205 transmits the target speed from the block 315 to the ego vehicles 105, as described above. After the block 320, the process 300 ends.

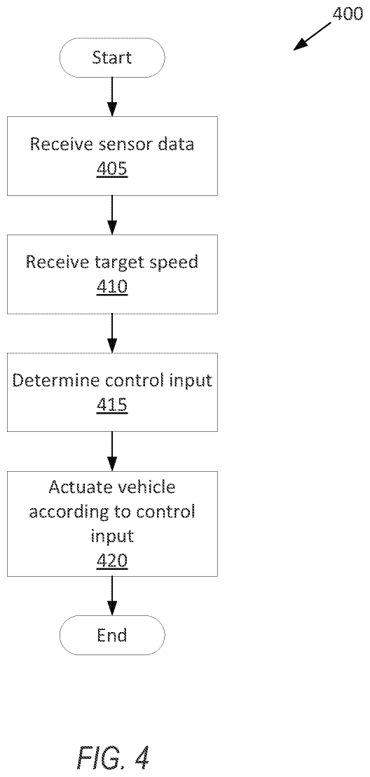

FIG. 4 is a flowchart illustrating an example process 400 for operating one of the ego vehicles 105 based on the target speed. The memory of the vehicle computer 210 stores executable instructions for performing the steps of the process 400 and/or programming can be implemented in structures such as mentioned above. As a general overview of the process 400, the vehicle computer 210 receives sensor data from the vehicle sensors 215, receives the target speed from the remote computer 205, determines the control input, and actuates a component of the vehicle according to the control input. The vehicle computer 210 may perform the process 400 continuously for as long as the ego vehicle 105 remains within the range of the infrastructure transceiver 135.

The process 400 begins in a block 405, in which the vehicle computer 210 receives sensor data from the vehicle sensors 215.

Next, in a block 410, the vehicle computer 210 receives the target speed from the remote computer 205, as described above.

Next, in a block 415, the vehicle computer 210 determines the control input based on the target speed from the block 410 and the sensor data from the block 405, e.g., using the “best response” algorithm described above or the adaptive cruise control described above.

Next, in a block 420, the vehicle computer 210 actuates at least one component of the ego vehicle 105, e.g., the propulsion system 220 and/or the brake system 225, according to the control input determined in the block 415, as described above. After the block 420, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. Operations, systems, and methods described herein should always be implemented and/or performed in accordance with an applicable owner's/user's manual and/or safety guidelines.

The disclosure has been described in an illustrative manner, and it is to be understood that the terminology which has been used is intended to be in the nature of words of description rather than of limitation. The adjectives “first,” “second,” and “third” are used throughout this document as identifiers and are not intended to signify importance, order, or quantity. Use of “in response to,” “upon determining,” etc. indicates a causal relationship, not merely a temporal relationship. Many modifications and variations of the present disclosure are possible in light of the above teachings, and the disclosure may be practiced otherwise than as specifically described.

What is claimed is:

1. A system comprising a remote computer, the remote computer including a processor and a memory, the memory storing instructions executable by the processor to:
determine a vehicle density over a predefined segment of a road, the vehicle density being a number of vehicles per road length over the predefined segment, the vehicles being remote from the remote computer;
determine a target speed based on the vehicle density, the target speed being a speed at which an ego vehicle of the vehicles attempts to travel when unimpeded in a forward direction by remaining vehicles of the vehicles; and
transmit the target speed to the ego vehicle.

2. The system of claim 1, wherein the vehicles are traveling at respective actual speeds, and the instructions further include instructions to determine the target speed based on optimizing a combination of a mean of the actual speeds and a spread of the actual speeds, the spread being a difference between a highest speed of the actual speeds and a lowest speed of the actual speeds.

3. The system of claim 2, wherein the combination of the mean and the spread is a difference between the mean and the spread with at least one of the mean and the spread weighted by a tradeoff parameter.

4. The system of claim 2, wherein the actual speeds of the vehicles for each value of the mean and of the spread are from a same time.

5. The system of claim 4, wherein the instructions further include instructions to optimize the combination of the mean and the spread over a time horizon.

6. The system of claim 1, wherein the vehicles are traveling at respective actual speeds, and the instructions further include instructions to determine the target speed based on minimizing a spread of the actual speeds, the spread being a difference between a highest speed of the actual speeds and a lowest speed of the actual speeds.

7. The system of claim 6, wherein the actual speeds of the vehicles for each value of the spread are from a same time.

8. The system of claim 1, wherein the vehicles are traveling at respective actual speeds, and the instructions further include instructions to determine the target speed based on maximizing a mean of the actual speeds.

9. The system of claim 8, wherein the actual speeds of the vehicles for each value of the mean are from a same time.

10. The system of claim 1, wherein the vehicle density is a mean over a plurality of timesteps of an instantaneous vehicle density at the timesteps.

11. The system of claim 1, further comprising the ego vehicle, the ego vehicle including a vehicle computer, the vehicle computer being programmed to execute an adaptive cruise control based on the target speed.

12. The system of claim 1, wherein the target speed is a posted speed limit for the road.

13. The system of claim 1, wherein the instructions further include instructions to broadcast the target speed over the predefined segment of the road.

14. The system of claim 1, wherein the remote computer is communicatively coupled to the ego vehicle, and the remote computer is not communicatively coupled to at least one of the remaining vehicles.

15. A method comprising:
determining a vehicle density over a predefined segment of a road, the vehicle density being a number of vehicles per road length over the predefined segment, the vehicles being remote from the remote computer;
determining a target speed based on the vehicle density, the target speed being a speed at which an ego vehicle of the vehicles attempts to travel when unimpeded in a forward direction by remaining vehicles of the vehicles; and
transmitting the target speed to the ego vehicle.

16. The method of claim 15, further comprising executing an adaptive cruise control on board the ego vehicle based on the target speed.

17. The method of claim 15, wherein the vehicles are traveling at respective actual speeds, the method further comprising determining the target speed based on optimizing a combination of a mean of the actual speeds and a spread of the actual speeds, the spread being a difference between a highest speed of the actual speeds and a lowest speed of the actual speeds.

18. The method of claim 17, wherein the combination of the mean and the spread is a difference between the mean and the spread with at least one of the mean and the spread weighted by a tradeoff parameter.

19. The method of claim 17, wherein the actual speeds of the vehicles for each value of the mean and of the spread are from a same time.

20. The method of claim 19, further comprising optimizing the combination of the mean and the spread over a time horizon.
